(19) United States
(12) Patent Application Publication
(10) Pub. No.: US 2022/0119917 A1
(43) Pub. Date: Apr. 21, 2022

(54) METHOD FOR RECOVERING COPPER, MOLYBDENUM, AND PRECIOUS METALS FROM SILICATE-CONTAINING ORE

(71) Applicant: FREEPORT MINERALS CORPORATION, Phoenix, AZ (US)

(72) Inventors: Brenda Lizzet Mota, Los Alamos, NM (US); Thomas R. Bolles, Tucson, AZ (US); Christine Rae Green, Safford, AZ (US); Santosh Srivatsa Gunturi, Safford, AZ (US); Manuel G. Villalba, JR., Safford, AZ (US)

(73) Assignee: FREEPORT MINERALS CORPORATION, Phoenix, AZ (US)

(21) Appl. No.: 17/496,311

(22) Filed: Oct. 7, 2021

Related U.S. Application Data
(60) Provisional application No. 63/106,535, filed on Oct. 28, 2020.
(60) Provisional application No. 63/092,665, filed on Oct. 16, 2020.

(51) Int. Cl. C22B 34/34; C22B 11/00; C22B 3/04; C25C 1/12

(52) U.S. Cl. CPC C22B 34/34; C25C 1/12; C22B 3/04; C22B 11/04

(57) ABSTRACT

The present disclosure provides a method of recovering copper, molybdenum, and a precious metal value from a metal-bearing material, the method comprising bulk flotation of the metal-bearing material to form a flotation product, wherein the metal-bearing material comprises a copper compound, a molybdenum compound, at least one precious metal value, and a silicate, pressure oxidizing the flotation product to form a pressure oxidized discharge, separating the pressure oxidized discharge to form a separated liquid and separated solid, extracting molybdenum, via a molybdenum solution extraction, from the separated liquid to form a molybdenum-containing stream and a copper-containing stream, extracting copper, via a copper solution extraction, from the copper-containing stream, and extracting the precious metal value, via a cyanide leaching process, from the separated solid.

### CROSS-REFERENCE TO RELATED APPLICATIONS

This application claims priority to, and the benefit of, U.S. Provisional Application Ser. No. 63/106,535, filed Oct. 28, 2020, entitled “METHOD FOR RECOVERING COPPER, MOLYBDENUM, AND PRECIOUS METALS FROM SILICATE-CONTAINING ORE”. This application also claims priority to, and the benefit of U.S. Provisional Application Ser. No. 63/092,665, filed Oct. 16, 2020, entitled “METHOD FOR RECOVERING COPPER, MOLYBDENUM, AND PRECIOUS METALS FROM SILICATE-CONTAINING ORE”. The entire contents of the foregoing applications are incorporated by reference herein in their entireties.

### FIELD

The present invention generally relates to the processing of copper- and molybdenum-containing ores and, more particularly, to the processing and refining of copper, molybdenum, and precious metals from ores containing silicates.

### BACKGROUND

The recovery of molybdenum and/or copper from ore products can be complicated by the presence of various silicates. For example, silicates such as talc, clay, and pyrophyllite can impede the physical separation of molybdenum and/or copper compounds from the other constituents of the ore. In many processes, silicates can accumulate, agglomerate, and otherwise adversely affect the physical systems and apparatus used to separate and isolate copper, molybdenum, and precious metal values.

Conventional techniques for isolating and recovering copper, molybdenum, and precious metal values from ore can be inhibited by the presence of significant amounts of silicates in the ore. For example, flotation can be used as a recovery method to process metal-bearing ores. Because silicates, such as pyrophyllite, are sticky and have a relatively low density, they can interfere with the flotation of the metal value to be recovered. These minerals are also naturally hydrophobic and thus float easily in froth flotation processes. They have surface properties much like molybdenum disulfide and are therefore difficult to separate from molybdenum minerals by traditional flotation processes. This can result in the production of low grade—often unsalable—molybdenum concentrates. Accordingly, improved methods and systems for efficiently recovering copper and/or molybdenum present in silicate-containing ore are desired.

### SUMMARY OF THE INVENTION

A method of recovering copper, molybdenum, and a precious metal value from a metal-bearing material, may comprise bulk flotation of the metal-bearing material to form a flotation product, wherein the metal-bearing material comprises a copper compound, a molybdenum compound, at least one precious metal value, and a silicate, pressure oxidizing the flotation product to form a pressure oxidized discharge, separating the pressure oxidized discharge to form a separated liquid and separated solid, extracting molybdenum, via a molybdenum solution extraction, from the separated liquid to form a molybdenum-containing stream and a copper-containing stream, extracting copper, via a copper solution extraction, from the copper-containing stream, and extracting the precious metal value, via a cyanide leaching process, from the separated solid.

In various embodiment, the method may comprise conducting an organic washing process on the molybdenum-containing stream and conducting an organic stripping process on the molybdenum-containing stream. The method may comprise conducting a crystallization process on the molybdenum containing stream. Extracting the precious metal value from the separated solid may further comprise a hot lime boil. Extracting copper from the copper-containing stream may further comprise electrowinning the copper-containing stream. The method may further comprise cooling the pressure oxidized discharge via flash letdown process.

A method of recovering copper, molybdenum, and a precious metal value from a metal-bearing material may comprise bulk flotation of the metal-bearing material to form a flotation product, wherein the metal-bearing material comprises a copper compound, a molybdenum compound, at least one precious metal value, and a silicate, pressure oxidizing the flotation product to form a pressure oxidized discharge, separating the pressure oxidized discharge to form a separated liquid and separated solid, extracting molybdenum, via a molybdenum solution extraction, from the separated liquid to form a molybdenum-containing stream and a copper-containing stream, extracting copper, via a copper solution extraction, from the copper-containing stream, and extracting the precious metal value, via a thiosulfate leaching process, from the separated solid.

In various embodiments, the method may comprise conducting an organic washing process on the molybdenum-containing stream and conducting an organic stripping process on the molybdenum-containing stream. The method may comprise conducting a crystallization process on the molybdenum containing stream. Extracting the precious metal value from the separated solid may further comprise a hot lime boil. Extracting copper from the copper-containing stream may further comprise electrowinning the copper-containing stream. The method may further comprise cooling the pressure oxidized discharge via flash letdown process.

A method of recovering copper, molybdenum, and a precious metal value from a metal-bearing material may comprise bulk flotation of the metal-bearing material to form a flotation product, wherein the metal-bearing material comprises a copper compound, a molybdenum compound, at least one precious metal value, and a silicate, pressure oxidizing the flotation product to form a pressure oxidized discharge, hot curing the pressure oxidized discharge to form a product stream, separating the pressure oxidized discharge to form a separated liquid and separated solid, extracting molybdenum, via a molybdenum solution extraction, from the separated liquid to form a molybdenum-containing stream and a copper-containing stream, extracting copper, via a copper solution extraction, from the copper-containing stream, and extracting the precious metal value from the separated solid.

In various embodiments, the method may comprise conducting an organic washing process on the molybdenum-containing stream and conducting an organic stripping process on the molybdenum-containing stream. The method may comprise conducting a crystallization process on the molybdenum containing stream. In various embodiments, extracting the precious metal value from the separated solid may further comprise a cyanide leaching process. In various embodiments, extracting the precious metal value from the separated solid may further comprise a thiosulfate leaching process. In various embodiments, extracting the precious metal value from the separated solid may further comprise a hot lime boil and a cyanide leaching process. Extracting copper from the copper-containing stream may further comprise electrowinning the copper-containing stream. The method may further comprise cooling the pressure oxidized discharge via flash letdown process. The lime boil may utilize a temperature of between approximately 0° C. and approximately 180° C. for a duration of between approximately 0 to 6 hours. The hot curing may comprise holding the pressure oxidized discharge at a temperature between 0 and 180° C. for between 4 to 12 hours.

### BRIEF DESCRIPTION OF THE DRAWINGS

FIG. 1 illustrates a process for recovering copper, molybdenum, and precious metal values from a metal-bearing material in accordance with various embodiments of the present disclosure;

FIG. 2 illustrates a bulk treatment process for recovering copper, molybdenum, and precious metal values from a metal-bearing material in accordance with various embodiments of the present disclosure;

FIG. 3 illustrates a process for recovering precious metal values from a metal-bearing material in accordance with various embodiments of the present disclosure;

FIG. 4 illustrates a process for recovering molybdenum values from a metal-bearing material in accordance with various embodiments of the present disclosure;

FIG. 5 illustrates a process for recovering copper values from a metal-bearing material in accordance with various embodiments of the present disclosure; and

FIG. 6 illustrates exemplary recovery data for a process for recovering copper, molybdenum, and precious metal values in accordance with various embodiments of the present disclosure.

### DETAILED DESCRIPTION

The present disclosure refers to and describes methods and systems for recovering copper and molybdenum from silicate-containing ores. It should be appreciated that the broader process steps described herein may be accomplished by a variety of equipment configurations and sub-process steps, each of which are within the scope of the present invention. Particular equipment is generally described as being suitable for copper, molybdenum, and precious metal value recovery. However, other equipment may be implemented or combined with other equipment to accomplish the objectives described herein. Additionally or alternatively, the present system and method may be implemented or adapted to process other starting materials and/or to produce different final products.

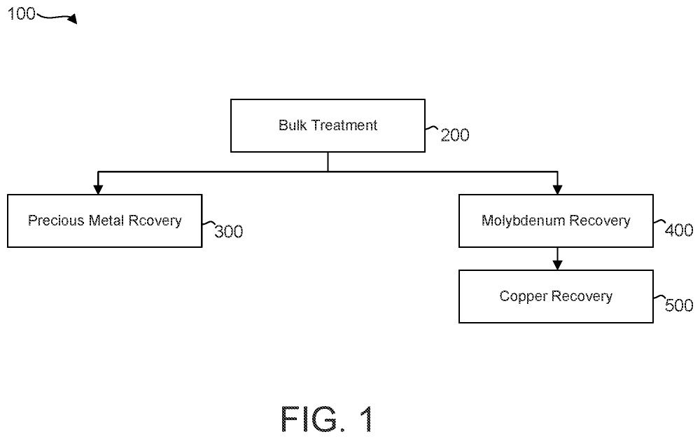

In accordance with various embodiments and with reference to FIG. 1, a method 100 for recovering copper, molybdenum, and precious metals from silicate-containing ore is illustrated. The process steps are illustrated in block diagram format to re-emphasize that the present invention is not limited to any specific hardware or processing equipment, with many different types of operating components being suitable for use in the disclosed system and process.

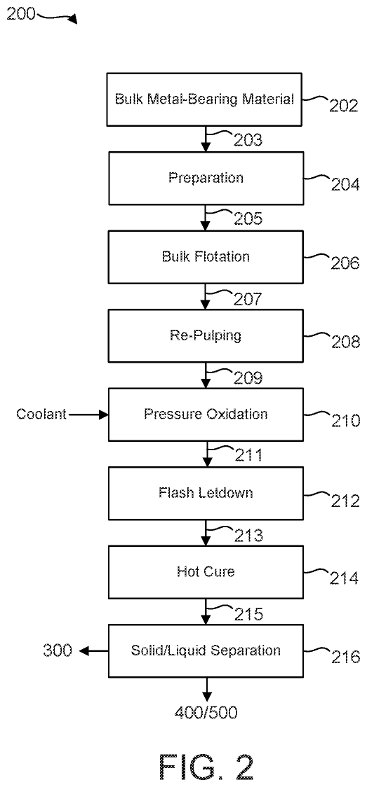

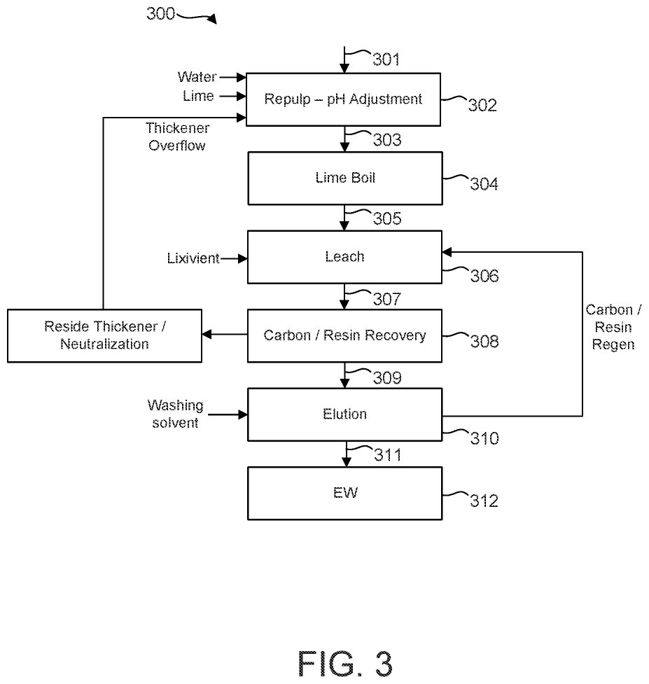

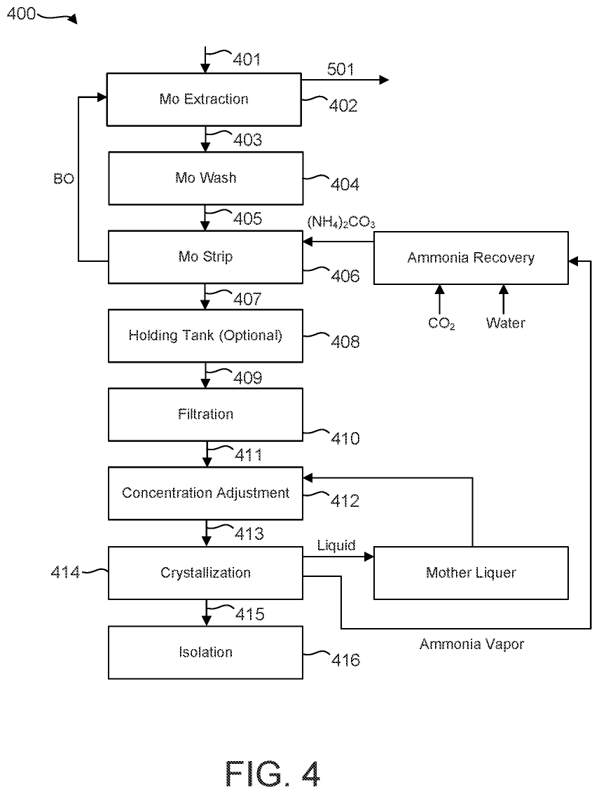

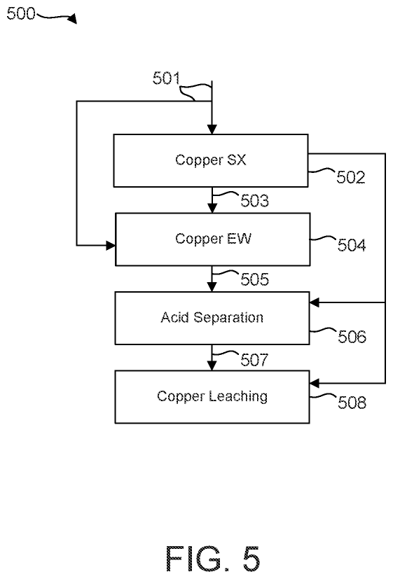

In accordance with various embodiments, method 100 may comprise a bulk treatment step 200 configured to prepare a metal-bearing material for processing to extract precious metals, molybdenum, and/or copper from the metal-bearing material. An exemplary bulk treatment process is illustrated in FIG. 2. At or near the end of bulk treatment step 200, a solid-liquid separation step may separate the solution into a solution and solids. The solids may be directed to a precious metal recovery step 300, where precious metal values may be extracted from the solids (FIG. 3), while the solution may be directed to a molybdenum recovery step 400 (FIG. 4) and a copper recovery step 500 (FIG. 5) in which molybdenum and/or copper may be extracted from the solution. While described herein as utilizing extraction processes to extract precious metal values from the solids and extracting molybdenum and copper from the solution, the processes herein are not limited in this regard and other processes may be utilized to extract precious metal values, molybdenum, and/or copper from the discharge.

With reference to FIG. 2, an exemplary bulk treatment step 200 is illustrated in greater detail. As illustrated in FIG. 2, method 200 initially involves forwarding a bulk metal-bearing material 202 to a preparation step 204 via input 203. Bulk metal-bearing material 202 can comprise, for example, unprocessed copper minerals, molybdenum minerals, and precious metal values. In various embodiments, bulk metal-bearing material 202 can comprise ores and/or concentrates containing chalcopyrite (CuFeS2), chalcocite (Cu2S), bornite (Cu5FeS4), covellite (CuS), malachite (Cu2CO3(OH)2), pseudomalachite (Cu5[(OH)2PO4]2), azurite (Cu3(CO3)2(OH)2), chrysocolla ((Cu,Al)2H2Si2O5(OH)4.nH2O), cuprite (Cu2O), brochanite (CuSO4.3Cu(OH)2), atacamite (Cu2[OH3Cl]), and other copper bearing minerals or materials and mixtures thereof.

In various embodiments, bulk metal-bearing material 200 can comprise molybdenum minerals such, for example, as molybdenite (MoS2). In various embodiments, molybdenum may be present in an amount less than, equal to, or greater than the amount of copper present in bulk metal-bearing material 202 and may additionally include precious metal values, including but not limited to, gold, silver, platinum group metals, zinc, nickel, cobalt, uranium, rhenium, rare earth metals, and the like. For example, bulk metal-bearing material 202 can comprise rhenium, as rhenium is typically present in molybdenum materials such as molybdenite.

In various embodiments, preparation 204 of bulk metal-bearing material comprises a physical conditioning of bulk metal-bearing material 202 such as, for example, via a size reduction process to achieve a prepared metal-bearing material 205. In various embodiments, bulk metal-bearing material 202 is subjected to size reduction such as grinding and/or crushing to reduce the average particle size of the material. In various embodiments, bulk metal-bearing material 202 is converted into a ground ore product which is typically in particulate form having an average particle size of about 50 micrometers to about 300 micrometers, however, is not limited in this regard and may comprise a different particle size for a given application.

Method 200 can further comprise a bulk flotation step 206, in various embodiments. In various embodiments, bulk metal-bearing material 202, and prepared metal-bearing material 205, comprises undesirable silicates, such as pyrophyllite. Physical properties of pyrophyllite, such as its relatively low density, high surface area, and adhesiveness can reduce the effectiveness and/or efficiency of metal recovery processes.

Bulk flotation step 206 can comprise, for example, forwarding physically prepared metal-bearing material 205 to a bulk flotation apparatus. For example, physically prepared metal-bearing material 205 can be introduced into a conventional flotation extraction system which employs numerous reagents, including various hydrocarbon compositions, as well as selected wetting agents. A wide variety of flotation chemicals may be used in connection with conventional flotation systems of the type described above including, but not limited to, butyl carbitol, allyl esters, and potassium xanthates. Typically, the “float” product associated with a representative flotation extraction system will contain the desired isolated copper compounds and molybdenum compounds, as well as the silicates, present in physically prepared metal-bearing material 205. In various embodiments, bulk flotation step 206 produces a flotation product 207 from prepared metal-bearing material 205.

In various embodiments, the “sink” product produced by bulk flotation step 206 comprises primarily the waste gangue, which may be discarded or further processed if desired. Bulk flotation step 206 may, for example, comprise multiple sequential flotation steps and, further, may include intervening grinding steps, depending on the particular type of ore being processed and other extrinsic considerations.

In various embodiments, method 200 can further comprise a re-pulping step 208. For example, in various embodiments, flotation product 207 may be optionally re-pulped with a liquid to form a feed material 209. In accordance with various embodiments, the liquid can be sourced from other portions of method 200 or external sources.

In various embodiments, feed material 209 produced by re-pulping step 208 is forwarded to pressure oxidation step 210. Alternatively, in various embodiments, flotation product 207 is forwarded directly to a pressure oxidation step 210 from bulk flotation step 206 without an intervening re-pulping step. In various embodiments, feed material 209 and/or flotation product 207 containing copper, molybdenum, silicate (e.g., pyrophyllite), and/or precious metal values is forwarded from a bulk flotation apparatus to a pressure oxidation vessel (e.g., autoclave).

Pressure oxidation step 210 of method 200 can, for example, comprise operating an autoclave in either a batch mode or a continuous mode. The autoclave may include a heater and one or more mixing motors having corresponding blades or agitators. The autoclave may also include one or more sparger-type agitators through which a free oxygen-containing gas is admitted under pressure into the autoclave in the form of a stream of bubbles. The autoclave may include additional or alternative components configured to facilitate effective mixing of the materials in flotation product 207 or feed material 209 within the autoclave. Further, a temperature and/or pressure within the autoclave may be selected for the desired oxidation reaction. For example, a coolant may be added to the autoclave to achieve a desired temperature in pressure oxidation step 210. The coolant may be sourced from within method 200 or external to method 200. For example, the coolant may be sourced from an external water source, from solution from an acid separation step within method 200, or from a mixture thereof. Water may be a particularly suitable coolant due to its role in the oxidation reactions occurring within the autoclave.

In various embodiments, pressure oxidation step 210 converts molybdenum sulfide (MoS2) present in flotation product 207 and/or feed material 209 to a molybdenum oxide (MoO3). For example, MoS2 in flotation product 207 and/or feed product 209 may oxidize to form MoO3 when heated in a pressure oxidation vessel (e.g., autoclave). During the heating process, an oxygenated atmosphere is maintained within the vessel, and as a result, MoO3 is generated in accordance with one or more variations of the following exothermic reaction:

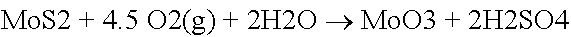

In various embodiments, flotation product 207 and/or feed material 209 in the autoclave may be subjected to pressures greater than about 400 psi and to temperatures greater than about 200° C., between approximately 200° C. to approximately 250° C., or more preferably approximately 215° C. to approximately 235° C. Although described with reference to specific operating parameters (e.g., temperature and pressure), any suitable operating parameters for oxidation of flotation product 207 and/or feed material 209 are within the scope of the present disclosure.

In various embodiments, flotation product 207 and/or feed material 209 is sufficiently oxidized to form an oxidized discharge 211. For example, method 200 can further comprise forwarding oxidized discharge 211 from pressure oxidation step 210 to flash letdown step 212. For example, oxidized discharge 211 can be forwarded to a flash tank or other type of equipment to reduce the temperature and/or pressure of oxidized discharge 211.

In various embodiments, oxidized discharge 211 may exit flash letdown step 212 as cooled oxidized discharge 213. Cooled oxidized discharge 213 may undergo a hot curing step 214. In various embodiments, hot curing step 214 may comprise holding cooled oxidized discharge 213 at a given temperature for a given time period. For example, in various embodiments, hot curing step 214 may comprise holding cooled oxidized discharge between approximately 0 to 180° C., or more preferably between approximately 40 to 90° C. for between approximately 4 to 12 hours, between approximately 6 to 10 hours, or more preferably approximately 8 hours. Cooled oxidized discharge 213 may exit hot curing step 214 as product stream 215.

Method 200 can further comprise a solid-liquid separation step 216. For example, product stream 215 (which comprises a slurry of oxidized metals and other components) can be sent to a solid-liquid separator. The solid-liquid separator may comprise various apparatus suitable for counter-current decantation, thickening, filtration, and centrifugation. In accordance with various embodiments, the solid-liquid separator is a counter-current decantation circuit. Suitable counter-current decantation circuits may include two or more thickeners operated in counter-current mode. However, the use of any number of thickeners, operated in series and/or in counter-current mode, is within the scope of the present disclosure.

In various embodiments, solid-liquid separation step 216 produces an overflow liquids fraction 401 (FIG. 4) and an underflow solids product 301 (FIG. 3), consisting principally of solids. Underflow solids product 301 can comprise, for example, undesirable solids, including silicates such as pyrophyllite and precious metal values. Overflow liquids fraction 401 can comprise, for example, molybdenum and copper containing compounds. As will be discussed further below, precious metals, including but not limited to silver and gold may be extracted from underflow solids product 301 in precious metal recovery step 300 while molybdenum and copper may be extracted from overflow liquids fraction 401 in molybdenum recovery step 400 and copper recovery step 500.

With reference to FIG. 3, a method 300 of recovering precious metal values from underflow solids product 301 is illustrated in accordance with an exemplary embodiment. Method 300 may be configured to recover one or more precious metal values. As previously discussed, precious metal values may include gold, silver, platinum group metals, zinc, nickel, cobalt, uranium, rhenium, rare earth metals, and the like. Precious metal values may be included in underflow solids product 301 exiting solid-liquid separation step 216 (FIG. 2) and may be processed as further set forth below to recover such precious metal values.

In various embodiments, underflow solids product 301 may be directed to a repulp—pH adjustment step 302. In repulp—pH adjustment step 302, water, lime, and a thickener overflow material may be added to underflow solid product 301 to increase the pH of the underflow solids product. In various embodiments, a basic input material such as lime may be added to underflow solids product 301 in repulp—pH adjustment step 302. However, the basic input material is not limited in this regard and may comprise a trona or soda ash material in various embodiments. Pulp 303 may exit repulp—pH adjustment step 302 and be directed to a lime boil step 304 in various embodiments.

In various embodiments, pressure oxidizing the flotation product may comprise using an acid solution. In various embodiments, the acid solution may have a concentration between around 0.1 g/L and around 500 g/L. In various embodiments, the acid solution may have a concentration between around 1 g/L and around 200 g/L. In various embodiments, the acid solution may have a concentration between around 1 g/L and around 100 g/L. In various embodiments, the acid solution may have a concentration between around 1 g/L and around 50 g/L. The acid solution may comprise sulfuric acid or a variant of thereof.

In various embodiments, lime boil step 304 may assist in liberating precious metals (e.g., silver from jarosite). In various embodiments, steam from an external source from within method 200 (e.g., flash letdown step 212) may be forwarded to increase temperature for the lime boil. In various embodiments, the lime boil may be carried out at any desired temperature for any desired time period. For example, in various embodiments, the lime boil may be conducted at a temperature between approximately 0 to 180° C., between approximately 45 to 135° C., or more preferably at approximately 90° C. for a time period of approximately 0 to 6 hours or more preferably approximately 2 to 4 hours.

Boiled pulp product 305 may exit lime boil step 304 and proceed to a leach step 306. In leach step 306, a lixiviant, such as cyanide or thiosulfate, may be added to boiled pulp product 305 to dissolve precious metal values into solution. In various embodiments, depending on the lixiviant chosen, leach step 306 may be a carbon in leach process, carbon in pulp process, resin in leach process, or resin in pulp process. Carbon or resin containing precious metal values may be separated from solution in the form of loaded pulp material 307 in a carbon/resin recovery step 308.

In various embodiments, an isolated carbon/resin material 309 may be directed to an elution step 310. In elution step 310, the isolated carbon/resin material 309 may be stripped using a washing solvent to remove precious metal values from the carbon and/or resin, which may then be directed to electrowinning step 312 via precious metal solution 311. Electrowinning step 312 may comprise an electrowinning circuit configured to carry out an electrowinning process to produce one or more precious metal cathodes, which may be collected as precious metal values.

Referring now to FIG. 4, molybdenum recovery step 400 is illustrated, in accordance with exemplary embodiments. Overflow liquids fraction 401 may be forwarded to molybdenum extraction step 402. Molybdenum extraction step 402, in addition to the other steps described herein, may be configured to extract molybdenum (Mo), rhenium (Re), and/or other metal values. In various embodiments, molybdenum extraction step 402 may be adapted to extract Mo values and/or Re values from an aqueous stage into an organic stage. Additionally, molybdenum extraction step 402 may be adapted to leave copper values and/or other metal values in an acidic aqueous phase. As one example of a suitable solution extraction implementation, molybdenum extraction step 402 may utilize Cyanex® 600, a tertiary amine, as the organic stage into which the Mo values and/or Re values are extracted. In exemplary embodiments, molybdenum extraction step 400 may be represented by the following chemical equation:

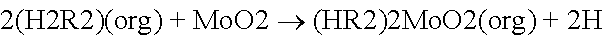

In various embodiments, molybdenum extraction step 402 may separate overflow liquids fraction 401 into copper loaded stream 501 (FIG. 5) and a loaded organic stream 403. In various embodiments, loaded organic stream 403 may be directed to a molybdenum washing step 404. In various embodiments, molybdenum washing step 404 may comprise washing loaded organic stream 403 with an aqueous solution. Washing tends to reduce entrained impurities in loaded organic stream 403.

Method 400 may further comprise directing a washed organic stream 405 to a molybdenum organic stripping step 406. Molybdenum organic stripping step 406 may comprise stripping the washed organic stream 405 with basic solution (e.g., ammonia, an alkali metal base solution, such as a solution including an alkali metal (e.g., sodium) hydroxide, alkali metal (e.g., sodium or potassium) carbonate or bicarbonate, or an alkaline earth metal base solution, such as a solution including an alkaline earth metal (e.g., calcium) carbonate or bicarbonate) to strip the Mo and/or Re values into the basic solution. In various embodiments, a barren organic solution may be recycled back into molybdenum extraction step 402. In exemplary embodiments, molybdenum organic stripping step 406 may be represented by the following chemical equation:

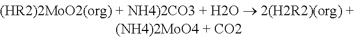

Moving on, in various embodiments, a stripped aqueous stream 407 may be directed to an optional holding tank 408 which may be filtered in filtration step 410. In various embodiments, stripped aqueous stream 407 may filter out particles greater than 0.5 μm, however is not limited in this regard. A filtered aqueous stream 411 may be forwarded to a concentration adjustment step 412 where the concentration of ammonium dimolybdate in filtered aqueous stream 411 may be varied. An adjusted aqueous stream 413 may be forwarded to a crystallization step 414 in various embodiments. Crystallization step 414 may utilize one or more parallel crystallizers operating at an elevated temperature. Additional or fewer crystallizers may be used depending on the configuration of the overall system. Similarly, the temperature and other conditions in the crystallizer system may be varied to suit the other process configuration variables and the variables that may be present in the adjusted aqueous stream 413. For example, in various embodiments, steam from other processes (e.g., flash letdown step 212 of FIG. 2) may assist in achieving a desired temperature. In various embodiments, liquid from crystallization step 414 may be recycled back into concentration adjustment step 412 while ammonia vapor may be combined with carbon dioxide and water and recycled into molybdenum organic stripping step 406. In exemplary embodiments, molybdenum organic stripping step 406 may be represented by the following chemical equation:

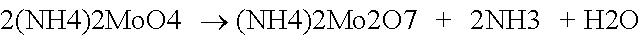

Method 400 may further comprise forwarding molybdenum crystals 415 to isolation step 416. The crystals in the solution may be separated from the solution in any suitable manner, with centrifugal separation being a non-limiting example of suitable separation systems. Accordingly, the centrifugal separation system may include two or more types of centrifuges and/or two or more groups of centrifuges dedicated to different separation objectives. In various embodiments, isolation step 416 may further comprise a calciner and packaging system, which may prepare the final molybdenum product for shipping and processing.

With reference now to FIG. 5, a copper recovery step 500 is illustrated, in accordance with exemplary embodiments. Copper recovery step 500 may be configured to extract copper values from copper loaded stream 501. In various embodiments, copper loaded stream 501 may exit molybdenum extraction step 402 (FIG. 4) and enter copper SX step 502. In various embodiments, copper loaded stream 501 may move directly to a copper electrowinning step 504. While not discussed herein in detail, copper SX step 502 may comprise any suitable system and/or processes for extraction of copper in solution form.

In various embodiments, copper bearing aqueous phase 503 may be directed to a copper electrowinning step 504. Copper electrowinning step 504 may comprise an electrowinning circuit configured to carry out an electrowinning process to produce one or more copper cathodes, which may be collected as copper values in a copper recovery step. In various embodiments, bleed from copper SX step 502 may be directed to an acid separation step 506 wherein the acid may be isolated. The recovered acid stream may be recycled for other copper leaching processes.

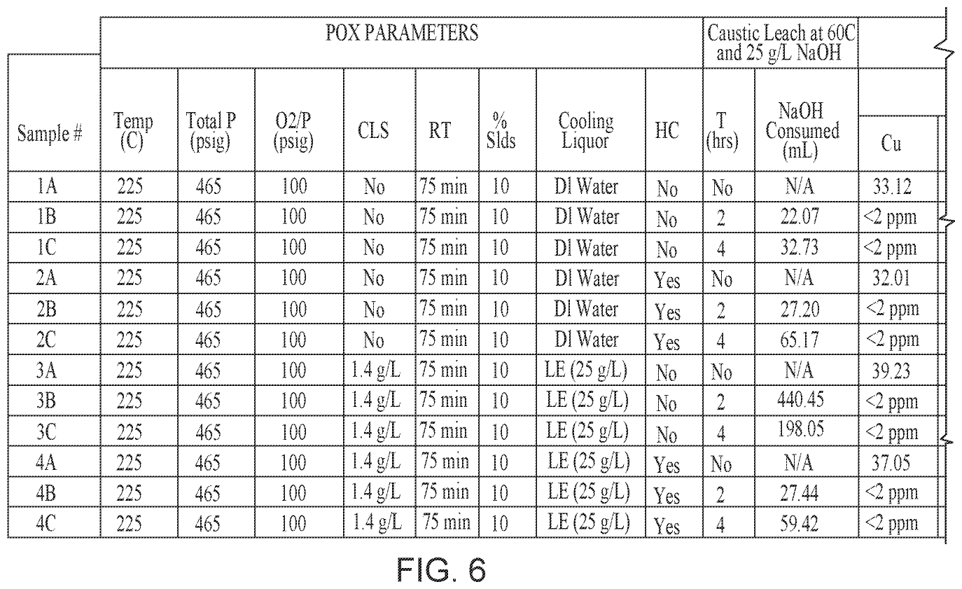

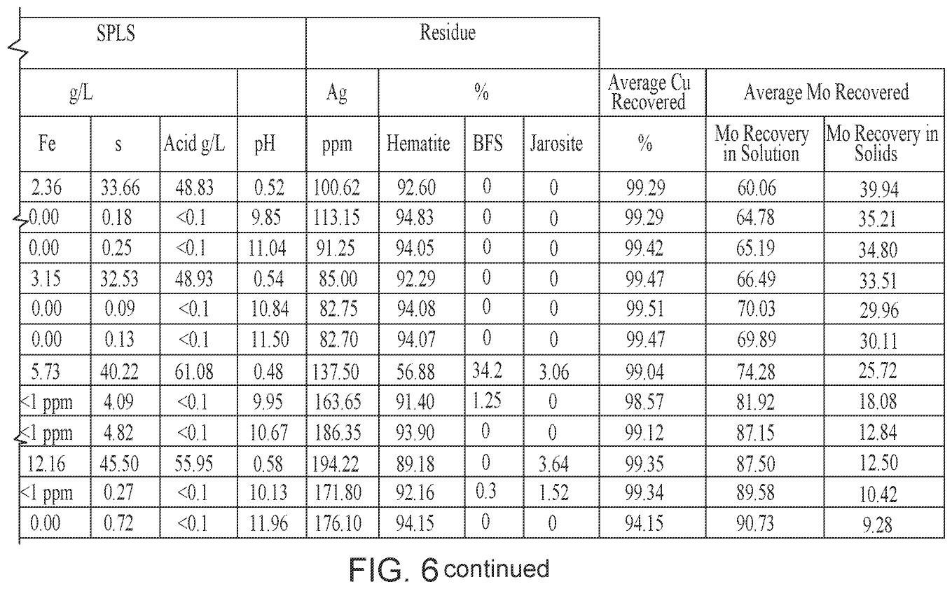

In various embodiments, the methods described herein may be utilized to maximize copper, molybdenum, and precious metal recovery from silicate-containing ores utilizing a single pressure oxidation step. Exemplary recovery data from such methods can be seen in FIG. 6. For example, referring to rows 3A-3C, a caustic leach process may be utilized to increase copper and molybdenum recovery in solution. Referring to rows 4A-4C, copper and molybdenum recovery in solution may be further increased when a hot cure process is conducted in addition to the caustic leach process.

It is believed that the disclosure set forth above encompasses at least one distinct invention with independent utility. While the invention has been disclosed in the exemplary forms, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

The method and system described herein may be implemented to convert molybdenum sulfide into molybdenum oxide. Additionally, the present method and system may be utilized to further refine the oxide to produce low-grade metallurgical oxide and/or ammonium dimolybdate. Additionally, the present method and system may be implemented to isolate copper and/or other metal values from the initial molybdenum sulfide concentrate materials. Other advantages and features of the present systems and methods may be appreciated from the disclosure herein and the implementation of the method and system.

What is claimed is:

1. A method of recovering copper, molybdenum, and a precious metal value from a metal-bearing material, the method comprising:
bulk flotation of the metal-bearing material to form a flotation product, wherein the metal-bearing material comprises a copper compound, a molybdenum compound, at least one precious metal value, and a silicate;
pressure oxidizing the flotation product to form a pressure oxidized discharge;
separating the pressure oxidized discharge to form a separated liquid and separated solid;
extracting molybdenum, via a molybdenum solution extraction, from the separated liquid to form a molybdenum-containing stream and a copper-containing stream;
extracting copper, via a copper solution extraction, from the copper-containing stream; and
extracting the precious metal value, via a cyanide leaching process, from the separated solid.

2. The method of claim 1, further comprising conducting an organic washing process on the molybdenum-containing stream and conducting an organic stripping process on the molybdenum-containing stream.

3. The method of claim 2, further comprising conducting a crystallization process on the molybdenum containing stream.

4. The method of claim 1, wherein extracting the precious metal value from the separated solid further comprises a hot lime boil.

5. The method of claim 1, wherein extracting copper from the copper-containing stream further comprises electrowinning the copper-containing stream.

6. The method of claim 1, further comprising cooling the pressure oxidized discharge via flash letdown process.

7. A method of recovering copper, molybdenum, and a precious metal value from a metal-bearing material, the method comprising:
bulk flotation of the metal-bearing material to form a flotation product, wherein the metal-bearing material comprises a copper compound, a molybdenum compound, at least one precious metal value, and a silicate;
pressure oxidizing the flotation product to form a pressure oxidized discharge;
separating the pressure oxidized discharge to form a separated liquid and separated solid;
extracting molybdenum, via a molybdenum solution extraction, from the separated liquid to form a molybdenum-containing stream and a copper-containing stream;
extracting copper, via a copper solution extraction, from the copper-containing stream; and
extracting the precious metal value, via a thiosulfate leaching process, from the separated solid.

8. The method of claim 7, further comprising conducting an organic washing process on the molybdenum-containing stream and conducting an organic stripping process on the molybdenum-containing stream.

9. The method of claim 8, further comprising conducting a crystallization process on the molybdenum containing stream.

10. The method of claim 7, wherein extracting the precious metal value from the separated solid further comprises a hot lime boil.

11. The method of claim 7, wherein extracting copper from the copper-containing stream further comprises electrowinning the copper-containing stream.

12. A method of recovering copper, molybdenum, and a precious metal value from a metal-bearing material, the method comprising:
bulk flotation of the metal-bearing material to form a flotation product, wherein the metal-bearing material comprises a copper compound, a molybdenum compound, at least one precious metal value, and a silicate;
pressure oxidizing the flotation product to form a pressure oxidized discharge;
hot curing the pressure oxidized discharge to form a product stream;
separating the pressure oxidized discharge to form a separated liquid and separated solid;
extracting molybdenum, via a molybdenum solution extraction, from the separated liquid to form a molybdenum-containing stream and a copper-containing stream;
extracting copper, via a copper solution extraction, from the copper-containing stream; and
extracting the precious metal value from the separated solid.

13. The method of claim 12, further comprising conducting an organic washing process on the molybdenum-containing stream and conducting an organic stripping process on the molybdenum-containing stream.

14. The method of claim 13, further comprising conducting a crystallization process on the molybdenum containing stream.

15. The method of claim 12, wherein extracting the precious metal value from the separated solid further comprises a cyanide leaching process.

16. The method of claim 12, wherein extracting the precious metal value from the separated solid further comprises a thiosulfate leaching process.

17. The method of claim 12, wherein extracting the precious metal value from the separated solid further comprises a hot lime boil and a cyanide leaching process.

18. The method of claim 12, further comprising cooling the pressure oxidized discharge via flash letdown process.

19. The method of claim 17, wherein the lime boil utilizes a temperature of between approximately 0° C. and approximately 180° C. for a duration of between approximately 0 to 6 hours.

20. The method of claim 12, wherein the hot curing comprises holding the pressure oxidized discharge at a temperature of between approximately 0 and 180° C. for a duration of between approximately 4 to 12 hours.
